(19) United States
(12) Patent Application Publication
(10) Pub. No.: US 2024/0317924 A1
(43) Pub. Date: Sep. 26, 2024

(54) AQUEOUS POLYURETHANE RESIN, SURFACE TREATMENT AGENT, AND LEATHER SURFACE-TREATED WITH THE SAME

(71) Applicant: NICCA CHEMICAL CO, LTD., Fukui-shi (JP)

(72) Inventors: Naoki NANBOKU, Fukui-shi (JP); Yusuke SAITO, Fukui-shi (JP); Kuniaki KONDO, Fukui-shi (JP); Masakazu NISHINO, Fukui-shi (JP)

(73) Assignee: NICCA CHEMICAL CO, LTD., Fukui-shi (JP)

(21) Appl. No.: 18/269,433

(22) PCT Filed: Nov. 17, 2021
(86) PCT No.: PCT/JP2021/042257

§ 371 Date: Jun. 23, 2023

(30) Foreign Application Priority Data
Dec. 24, 2020 (JP) 2020-215601

(51) Int. Cl. C08G 18/44; C08G 18/08; C08G 18/12; D06N 3/14

(52) U.S. Cl. CPC C08G 18/44; C08G 18/0866; C08G 18/12; D06N 3/146; C08G 2150/00; D06N 2203/068; D06N 2205/023; D06N 2209/1685

(57) ABSTRACT

An aqueous polyurethane resin is a chain-extended product of a neutralized product of an isocyanate group-terminated prepolymer which is a reaction product of (a) an organic polyisocyanate, (b) a polyol, (c) a compound having an anionic hydrophilic group and at least two active hydrogens and (d) a polyhydric alcohol, the chain-extended product being obtained by chain-extending the neutralized product with (e) a polyamine having two or more amino groups and/or imino groups, wherein the polyol contains at least one selected from the group consisting of polycarbonate diols each having a structural unit derived from a diol having a branched structure with an integer of 3 to 10 carbon atoms and polycarbonate diols having a structural unit derived from a diol having a linear structure with an odd number of 3 to 9 carbon atoms, and the polyhydric alcohol contains a polyhydric alcohol having at least three or more active hydrogens.

### TECHNICAL FIELD

The present invention relates to an aqueous polyurethane resin, a surface treatment agent, and leather surface-treated with the same.

### BACKGROUND ART

In a process for manufacturing synthetic leather having a skin layer made of a polyurethane resin, polyvinyl chloride (PVC) leather, or the like, the surface of the synthetic leather or the PVC leather is treated with a surface treatment agent in order to improve the wear resistance and matte property of the surface. Most of conventional resin compositions used in surface treatment agents are solvent-based resins containing an organic solvent such as dimethylformamide, toluene, or methyl ethyl ketone. However, being highly flammable and highly toxic, many of these organic solvents have problems such as a danger of fire, deterioration of a working environment, and pollution of an environment such as air and water quality. Further, in the manufacture of synthetic leather, the recovery of these organic solvents is also conducted, but the recovery is problematic due to high cost and labor required.

In recent years, organic solvents have been facing not only increased environmental regulations, but also a problem that organic solvents remaining inside leathers obtained by using organic solvent-soluble urethane resins have influence on human bodies such as skin disorders. To address this, the development of water-based surface treatment agents containing as little organic solvent as possible or containing no organic solvent is underway. In particular, for leather materials for use in automobile interior materials, water-based surface treatment agents are strongly demanded because of a risk that the residual organic solvents may affect the human bodies.

For example, International Publication No. WO2019/221088 (Patent Literature 1) describes a polyurethane resin containing a polyol component and an isocyanate component, in which (1) a polycarbonate diol component is contained as the polyol component and a linear aliphatic isocyanate component is contained as the isocyanate component, (2) the polycarbonate diol component has a weight average molecular weight of 500 to 3000 and has a structure including a structure derived from a diol having 3 to 10 carbon atoms, and (3) 10 mol % or more of the isocyanate component is a linear aliphatic isocyanate component having 4 to 10 carbon atoms. In Examples thereof, polycarbonate diol derived from 1,4-butanediol and 1,10-decanediol was used as the polycarbonate diol component. When this polyurethane resin is applied to a base material, both low temperature flexibility and chemical resistance can be achieved, but wear resistance is not sufficient.

In addition, International Publication No. WO2015/107933 (Patent Literature 2) describes a water-based surface treatment agent containing an aqueous polyurethane (A) having a 100% modulus in a range of 10 to 20 MPa and a carbodiimide-based cross-linking agent (B). In Examples thereof, an aqueous polyurethane using 1,6-hexanediol-based polycarbonatediol is described as the aqueous polyurethane (A). When a surface of a leather base material is treated with this water-based surface treatment agent, excellent wear resistance can be obtained, but there is a problem that the flexibility is deteriorated.

### CITATION LIST

### Patent Literature

[PTL 1] International Publication No. WO2019/221088
[PTL 2] International Publication No. WO2015/107933

### SUMMARY OF INVENTION

### Technical Problem

The present invention has been made in view of the above problems in the related art, and has an object to provide an aqueous polyurethane resin and a surface treatment agent capable of imparting excellent wear resistance to leather base materials without impairing flexibility and leather to which excellent wear resistance is imparted without flexibility impaired.

### Solution to Problem

The present inventors have conducted intensive studies to achieve the above-described object, and consequently have found that when a leather base material is surface-treated with an aqueous polyurethane resin prepared by using at least one of polycarbonate diols each derived from a diol having a branched structure with an integer number of 3 to 10 carbon atoms and polycarbonate diols each derived from a diol having a linear structure with an odd number of 3 to 9 carbon atoms, excellent wear resistance can be imparted to the leather base material without impairing flexibility. This finding has led to the completion of the present invention.

Specifically, an aqueous polyurethane resin of the present invention is an aqueous polyurethane resin that is a chain-extended product of a neutralized product of an isocyanate group-terminated prepolymer which is a reaction product of (a) an organic polyisocyanate, (b) a polyol, (c) a compound having an anionic hydrophilic group and at least two active hydrogens, and (d) a polyhydric alcohol, the chain-extended product being obtained by chain-extending the neutralized product with (e) a polyamine having two or more amino groups and/or imino groups, wherein the (b) polyol contains at least one selected from the group consisting of (b1) polycarbonate diols each having a structural unit derived from a diol having a branched structure with an integer of 3 to 10 carbon atoms and (b2) polycarbonate diols each having a structural unit derived from a diol having a linear structure with an odd number of 3 to 9 carbon atoms, and the (d) polyhydric alcohol contains a polyhydric alcohol having at least three or more active hydrogens.

In the aqueous polyurethane resin of the present invention, it is preferable that the (b1) polycarbonate diol be a polycarbonate diol having the structural unit derived from the diol having the branched structure with an integer of 3 to 10 carbon atoms and a structural unit derived from a diol having a linear structure with an integer of 3 to 10 carbon atoms, and the (b2) polycarbonate diol be at least one selected from the group consisting of a polycarbonate diol having the structural unit derived from the diol having the linear structure with an odd number of 3 to 9 carbon atoms and a structural unit derived from a diol having a linear structure with an even number of 4 to 10 carbon atoms and a polycarbonate diol having a structural unit derived from only the diol having the linear structure with an odd number of 3 to 9 carbon atoms.

Moreover, in the aqueous polyurethane resin of the present invention, it is preferable that a ratio of a total amount of the polycarbonate diols (b1) and (b2) in the (b) polyol be 40% by mass, and a ratio of the (d) polyhydric alcohol to a total amount of the (b) polyol, the (c) compound having an anionic hydrophilic group and at least two active hydrogens, and the (d) polyhydric alcohol be 0.1 to 1.5% by mass.

Furthermore, in the aqueous polyurethane resin of the present invention, it is preferable that a content of free isocyanate groups in the isocyanate group-terminated prepolymer be 0.2 to 4.0% by mass and the (a) organic polyisocyanate be at least one selected from the group consisting of aliphatic polyisocyanates and alicyclic polyisocyanates.

A surface treatment agent of the present invention is a surface treatment agent containing an aqueous polyurethane resin that is a chain-extended product of an isocyanate group-terminated prepolymer or a neutralized product thereof in which the isocyanate group-terminated prepolymer is a reaction product of at least (a) an organic polyisocyanate, (b) a polyol, and (d) a polyhydric alcohol, the chain-extended product being obtained by chain-extending the isocyanate group-terminated prepolymer or the neutralized product thereof with (e) a polyamine having two or more amino groups and/or imino groups, wherein the (b) polyol contains at least one selected from the group consisting of (b1) polycarbonate diols each having a structural unit derived from a diol having a branched structure with an integer of 3 to 10 carbon atoms and (b2) polycarbonate diols each having a structural unit derived from a diol having a linear structure with an odd number of 3 to 9 carbon atoms, and the (d) polyhydric alcohol contains a polyhydric alcohol having at least three or more active hydrogens.

In the surface treatment agent of the present invention, the aqueous polyurethane resin is preferably the aqueous polyurethane resin of the present invention.

Leather of the present invention comprises a leather base material and a surface treatment layer formed on a surface of the base material with the surface treatment agent of the present invention.

### Advantageous Effects of Invention

According to the present invention, it is possible to obtain leather to which wear resistance is imparted without impairing flexibility.

### DESCRIPTION OF EMBODIMENTS

Hereinafter, the present invention will be described in detail according to preferred embodiments thereof.

### [Aqueous Polyurethane Resin]

First, an aqueous polyurethane resin of the present invention will be described. The aqueous polyurethane resin of the present invention is a self-emulsifying type of an aqueous polyurethane resin that is a chain-extended product of a neutralized product of an isocyanate group-terminated prepolymer which is a reaction product of (a) an organic polyisocyanate, (b) a polyol, (c) a compound having an anionic hydrophilic group and at least two active hydrogens, and (d) a polyhydric alcohol, the chain-extended product being obtained by chain-extending the neutralized product with (e) a polyamine having two or more amino groups and/or imino groups. The term “aqueous” in the self-emulsifying type of the aqueous polyurethane resin means a property capable of creating a state in which, even when an emulsion dispersion prepared by emulsifying and dispersing a self-emulsifying type of a polyurethane resin in water such that the resin concentration is 35% by mass in the water is allowed to stand at 20° C. for 12 hours after the preparation, no separation or sedimentation is observed in the emulsion dispersion.

### (a) Organic Polyisocyanate

The (a) organic polyisocyanate used in the present invention is not particularly limited, and includes aromatic, aliphatic, and alicyclic polyisocyanates that have been generally used so far. For example, as the aromatic polyisocyanates, there are m-phenylene diisocyanate, p-phenylene diisocyanate, 2,4-tolylene diisocyanate, 2,6-tolylene diisocyanate, 4,4′-diphenylmethane diisocyanate, 2,4′-diphenylmethane diisocyanate, 3,3′-dimethyl-4,4′-biphenylene diisocyanate, 3,3′-dichloro-4,4′-biphenylene diisocyanate, 1,5-naphthalene diisocyanate, tolidine diisocyanate, tetramethylene xylylene diisocyanate, xylylene diisocyanate, and the like. As the aliphatic polyisocyanates, there are tetramethylene diisocyanate, pentamethylene diisocyanate, hexamethylene diisocyanate, dodecamethylene diisocyanate, trimethylhexamethylene diisocyanate, lysine diisocyanate, and the like. As the alicyclic polyisocyanates, there are isophorone diisocyanate, hydrogenated xylylene diisocyanate, 4,4′-dicyclohexylmethane diisocyanate, 3,3′-dimethyl-4,4′-dicyclohexylmethane diisocyanate, norbornane diisocyanate, 1,3-bis(isocyanatomethyl) cyclohexane, and the like. These organic polyisocyanates may be used alone or in combination of two or more. Among these organic polyisocyanates, aliphatic polyisocyanates and alicyclic polyisocyanates are preferable from the viewpoint that the obtained aqueous polyurethane resin has non-yellowing properties, and alicyclic polyisocyanates are more preferable from the viewpoint of heat resistance.

### (b) Polyol

The (b) polyol used in the present invention contains at least one selected from the group consisting of (b1) polycarbonate diols each having a structural unit derived from a diol having a branched structure with an integer of 3 to 10 carbon atoms and (b2) polycarbonate diols each having a structural unit derived from a diol having a linear structure with an odd number of 3 to 9 carbon atoms.

In the aqueous polyurethane resin of the present invention, it is preferable that the (b1) polycarbonate diol be a polycarbonate diol having the structural unit derived from the diol having the branched structure with an integer of 3 to 10 carbon atoms and a structural unit derived from a diol having a linear structure with an integer of 3 to 10 carbon atoms, and the (b2) polycarbonate diol be at least one selected from the group consisting of a polycarbonate diol having the structural unit derived from the diol having the linear structure with an odd number of 3 to 9 carbon atoms and a structural unit derived from a diol having a linear structure with an even number of 4 to 10 carbon atoms and a polycarbonate diol having a structural unit derived from only the diol having the linear structure with an odd number of 3 to 9 carbon atoms.

The weight average molecular weight of each of the (b1) polycarbonate diol and the (b2) polycarbonate diol is preferably 500 to 3000 and more preferably 800 to 2500. If the weight average molecular weight of each of the (b1) polycarbonate diol and the (b2) polycarbonate diol is less than the above lower limit, the flexibility of leather may be deteriorated. On the other hand, if the weight average molecular weight exceeds the above upper limit, the viscosity of the polycarbonate diol itself tends to be too high, which may make it difficult to handle the polycarbonate diol.

As the diol having a branched structure with an integer of 3 to 10 carbon atoms, there are 3-methyl-1,5-pentanediol, 2-methyl-1,3-propanediol, 2-butyl-2-ethyl-1,3-propanediol, and the like. As the diol having a linear structure with an odd number of 3 to 9 carbon atoms, there are 1,3-propanediol, 1,5-pentanediol, 1,7-heptanediol, 1,9-nonanediol, and the like. As the diol having a linear structure with an even number of 4 to 10 carbon atoms, there are 1,4-butanediol, 1,6-hexanediol, 1,8-octanediol, 1,10-decanediol, and the like.

Specifically, as the (b1) polycarbonate diols, there are polycarbonate diols derived from 3-methyl-1,5-pentanediol/1,6-hexanediol (for example, Kuraray Polyol C-1090 (weight average molecular weight: 1000), Kuraray Polyol C-2090 (weight average molecular weight: 2000), and Kuraray polyol C-3090 (weight average molecular weight: 3000) manufactured by Kuraray Co., Ltd.), polycarbonate diols derived from 2-methyl-1,3-propanediol (for example, ETERNACOLL UP-100 (weight average molecular weight: 1000) and ETERNACOLL UP-200 (weight average molecular weight: 2000) manufactured by Ube Industries, Ltd.), and the like. Specifically, as the (b2) polycarbonate diols, there are polycarbonate diols derived from 1,5-pentanediol/1,6-hexanediol (for example, Duranol T5651 (weight average molecular weight: 1000) and Duranol T5652 (weight average molecular weight: 2000) manufactured by Asahi Kasei Chemicals Corporation), polycarbonate diols derived from 1,3-propanediol (for example, HS PD-2003 (weight average molecular weight: 2000) manufactured by Hokoku Corporation), and the like.

In the aqueous polyurethane resin of the present invention, the ratio of the total amount of the polycarbonate diols (b1) and (b2) in the (b) polyol is preferably 40% by mass or more, more preferably 50% by mass or more, particularly preferably 90% by mass or more, and most preferably 100% by mass from the viewpoints of the wear resistance and flex resistance of leather. If the ratio of the total amount of the polycarbonate diols (b1) and (b2) is less than the above lower limit, at least one of the wear resistance and flex resistance of leather may degrade.

Moreover, in the aqueous polyurethane resin of the present invention, in the case where the ratio of the total amount of the polycarbonate diols (b1) and (b2) in the (b) polyol is less than 100% by mass, a polyol other than the polycarbonate diols (b1) and (b2) (hereinafter, also referred to as “other polyol”) is contained. Examples of the other polyol include high-molecular weight polyols such as polyether-based polyols, polyester-based polyols, and polycarbonate-based polyols other than the polycarbonate diols (b1) and (b2) (hereinafter, also referred to as “other polycarbonate-based polyols”), and low-molecular weight diols.

Examples of the polyether-based polyols include polymers of alkylene oxides such as ethylene oxide, propylene oxide, and butylene oxide. Such a polymer may be a homopolymer of one type of alkylene oxides, or may be a copolymer of two or more types of alkylene oxides. In the case of a copolymer, the copolymer may be a random polymer or a block polymer. Such a polyether-based polyol preferably has a molecular weight of 400 to 5000. As the polyether-based polyol, a compound obtained by adding one or more types of alkylene oxides to a low-molecular weight dihydric alcohol can be also used. As the low-molecular weight dihydric alcohol, there are ethylene glycol, propylene glycol, 1,4-butanediol, and the like.

Examples of the polyester-based polyols include: a polyester-based polyol obtained by a dehydration condensation reaction of a diol component such as ethylene glycol, propylene glycol, 1,3-propanediol, 1,4-butanediol, 1,5-pentanediol, 3-methyl-1,5-pentanediol, 1,6-hexanediol, neopentyl glycol, diethylene glycol, triethylene glycol, tetraethylene glycol, polyethylene glycol having a molecular weight of 300 to 1000, dipropylene glycol, tripropylene glycol, bishydroxyethoxybenzene, 1,4-cyclohexanedimethanol, bisphenol A, bisphenol S, hydrogenated bisphenol A, hydroquinone, or their alkylene oxide adducts with a dicarboxylic acid component such as dimer acid, succinic acid, adipic acid, azelaic acid, sebacic acid, dodecanedicarboxylic acid, maleic anhydride, fumaric acid, 1,3-cyclopentanedicarboxylic acid, terephthalic acid, isophthalic acid, phthalic acid, 1,4-naphthalenedicarboxylic acid, 2,5-naphthalenedicarboxylic acid, 2,6-naphthalenedicarboxylic acid, naphthalic acid, biphenyldicarboxylic acid, 1,2-bisphenoxyethane-p, p′-dicarboxylic acid, or an anhydride or ester-forming derivative of dicarboxylic acid; a polyester-based polyol obtained by ring-opening polymerization of a cyclic ester compound such as ε-caprolactone; a polyester-based polyol obtained by copolymerization of these, and the like.

An example of the other polycarbonate-based polyols is a polycarbonate-based polyol obtained by a reaction of a glycol having an even number of carbon atoms such as 1,4-butanediol, 1,6-hexanediol, 1,8-octanediol, 1,10-decanediol, or diethylene glycol with diphenyl carbonate, phosgene, or the like.

Examples of the low-molecular weight diols include ethylene glycol, propylene glycol, diethylene glycol, 1,4-butanediol, 1,6-hexanediol, nonanediol, neopentyl glycol, and the like.

These other polyols may be used alone or in combination of two or more.

### (c) Compound Having Anionic Hydrophilic Group and at Least Two Active Hydrogens

The (c) compound having an anionic hydrophilic group and at least two active hydrogens used in the present invention is a compound containing an anionic hydrophilic group such as a carboxyl group, a carboxylate group, a sulfo group, or a sulfonate group, and two or more active hydrogen-containing groups such as hydroxy groups. As a result of copolymerization with this (c) compound having an anionic hydrophilic group and at least two active hydrogens, a self-emulsifying type of an aqueous polyurethane resin is obtained. Examples of the (c) compound include 2,2-dimethylolpropionic acid, 2,2-dimethylolbutanoic acid, 2,2-dimethylolbutyric acid, 2,2-dimethylolvaleric acid, dihydroxymaleic acid, 2,6-dihydroxybenzoic acid, and the like.

The content of the anionic hydrophilic group in the aqueous polyurethane resin of the present invention is preferably 0.3 to 3.0% by mass and more preferably 0.5 to 2.5% by mass from viewpoint of the emulsion stability, the storage stability, and the flex resistance of leather. If the content of the anionic hydrophilic group is less than the above lower limit, the emulsion stability and storage stability of the aqueous polyurethane resin tend to decrease, so that the aqueous polyurethane resin may not be used stably. On the other hand, if the content of the anionic hydrophilic group exceeds the above upper limit, the aqueous polyurethane resin tends to become so hard that the flexibility of leather may decrease.

### (d) Polyhydric Alcohol

The (d) polyhydric alcohol used in the present invention includes a polyhydric alcohol having at least three or more active hydrogens. Examples of the polyhydric alcohol include trihydric or higher polyhydric alcohols having a low molecular weight such as trimethylolpropane, pentaerythritol, and sorbitol. In addition, as the (d) polyhydric alcohol, a compound having a molecular weight of 500 or less in which one or more types of alkylene oxides are added to such a trihydric or higher polyhydric alcohol having a low molecular weight or a low-molecular weight polyalkylenepolyamine, or the like can be used. As the low-molecular weight polyalkylenepolyamine, there are ethylenediamine, diethylenetriamine, triethylenetetramine, and the like. As the alkylene oxides, there are ethylene oxide, propylene oxide, butylene oxide, and the like. Among such polyhydric alcohols, trihydric to tetrahydric alcohols are preferable, and trihydric alcohols are more preferable from the viewpoints of the wear resistance and flex resistance of leather.

Moreover, in the aqueous polyurethane resin of the present invention, the ratio of the (d) polyhydric alcohol to the total amount of the (b) polyol, the (c) compound having an anionic hydrophilic group and at least two active hydrogens, and the (d) polyhydric alcohol is preferably 0.1 to 1.5% by mass and more preferably 0.3 to 1.1% by mass from the viewpoints of the wear resistance and flex resistance of leather. If the ratio of the (d) polyhydric alcohol is less than the above lower limit, the cross-linking density of the aqueous polyurethane resin tends to be low and the wear resistance of leather may be insufficient. On the other hand, if the ratio of the (d) polyhydric alcohol exceeds the above upper limit, the cross-linking density of the aqueous polyurethane resin tends to be too high and the flex resistance of leather may decrease.

### (e) Polyamine

The (e) polyamine used in the present invention contains two or more amino groups and/or imino groups. Examples of such polyamine include: diamines such as ethylenediamine, propylenediamine, tetramethylenediamine, hexamethylenediamine, diaminocyclohexylmethane, hydrazine, 2-methylpiperazine, isophoronediamine, norboranediamine, diaminodiphenylmethane, tolylenediamine, and xylylenediamine; polyamines such as diethylenetriamine, triethylenetetramine, tetraethylenepentamine, and iminobispropylamine; amidoamine derived from diprimary amine and monocarboxylic acid; water-soluble amine derivatives such as monoketimine of diprimary amine; dihydrazide oxalate, dihydrazide malonate, dihydrazide succinate, dihydrazide glutarate, dihydrazide adipate, dihydrazide sebacate, dihydrazide maleate, dihydrazide fumarate, dihydrazide itaconate, and hydrazine derivatives of 1,1′-ethylenehydrazine, 1,1′-trimethylene hydrazine, 1,1′-(1,4-butylene)dihydrazine, or the like. These polyamines may be used alone or in combination of two or more. The amount of the (e) polyamine used is preferably such an amount that 0.8 to 1.2 equivalents of amino groups and/or the like are contained relative to the free isocyanate groups in the isocyanate group-terminated prepolymer to be described later.

### (Isocyanate Group-Terminated Prepolymer)

The isocyanate group-terminated prepolymer used in the present invention is a reaction product of the (a) organic polyisocyanate, the (b) polyol, the (c) compound having an anionic hydrophilic group and at least two active hydrogens, and the (d) polyhydric alcohol.

A method for producing such an isocyanate group-terminated prepolymer is not particularly limited, and examples thereof are conventionally known methods including a one-stage so-called one-shot method and a multi-stage isocyanate polyaddition reaction method. The reaction temperature is preferably 40 to 150° C. For this production, a reaction catalyst such as dibutyltin dilaurate, stannous octoate, dibutyltin di-2-ethylhexoate, triethylamine, triethylenediamine, N-methylmorpholine, or bismath tris(2-ethylhexanoate) or a reaction inhibitor such as phosphoric acid, sodium hydrogen phosphate, p-toluenesulfonic acid, adipic acid, or benzoyl chloride may be added as needed.

Moreover, an organic solvent nonreactive with an isocyanate group may be added during the reaction or after the end of the reaction. Examples of such an organic solvent include acetone, methyl ethyl ketone, methyl isobutyl ketone, tetrahydrofuran, dioxane, dimethylformamide, dimethyl sulfoxide, toluene, xylene, ethyl acetate, butyl acetate, methylene chloride, and the like. Among these organic solvents, methyl ethyl ketone, toluene, and ethyl acetate are particularly preferable. These organic solvents can be removed by heating under reduced pressure after the prepolymer is emulsified and dispersed and chain-extended.

In the production of the isocyanate group-terminated prepolymer, a mole ratio (NCO/OH) between isocyanate groups and hydroxyl groups in the raw materials is preferably 2.0/1.0 to 1.1/1.0 and more preferably 1.7/1.0 to 1.25/1.0. When the mole ratio between isocyanate groups and hydroxyl groups in the raw materials is adjusted within the above range, an isocyanate group-terminated prepolymer having a desired content of free isocyanate groups can be obtained. On the one hand, if the mole ratio between isocyanate groups and hydroxyl groups in the raw materials is less than the above lower limit, the content of free isocyanate groups tends to be too low. On the other hand, if the mole ratio exceeds the above upper limit, the content of free isocyanate groups tends to be too high.

The content of free isocyanate groups in the isocyanate group-terminated prepolymer thus obtained is preferably 0.2 to 4.08 by mass and more preferably 0.6 to 3.0% by mass. If the content of free isocyanate groups is less than the above lower limit, the viscosity of the isocyanate group-terminated prepolymer during the production tends to increase so much that the isocyanate group-terminated prepolymer is disadvantageous in terms of cost due to the necessity of a large amount of organic solvent and tends to be difficult to emulsify and disperse. On the other hand, if the content of free isocyanate groups exceeds the above upper limit, a balance of the water solubility tends to change greatly between after emulsification and dispersion and after chain-extension with the (e) polyamine, and the storage stability over time or the processing stability of the aqueous polyurethane resin may decrease. Moreover, the flex resistance of leather may decrease.

Note that since all of the (a) organic polyisocyanate, the (b) polyol, the (c) compound having an anionic hydrophilic group and at least two active hydrogens, and the (d) polyhydric alcohol have multiple reaction points, the isocyanate group-terminated prepolymer obtained by a reaction of the (a) organic polyisocyanate, the (b) polyol, the (c) compound having an anionic hydrophilic group and at least two active hydrogens, and the (d) polyhydric alcohol has a complicated structure and cannot be directly expressed in a general formula (structural formula).

### (Neutralized Product of Isocyanate Group-Terminated Prepolymer)

The neutralized product of the isocyanate group-terminated prepolymer used in the present invention is an isocyanate group-terminated prepolymer in which the anionic hydrophilic group is neutralized. The neutralized product of the isocyanate group-terminated prepolymer described above may be produced by (i) performing a known method to neutralize the anionic hydrophilic group in the isocyanate group-terminated prepolymer obtained by reacting the (a) organic polyisocyanate, the (b) polyol, the (c) compound having an anionic hydrophilic group and at least two active hydrogens, and the (d) polyhydric alcohol or may be produced by (ii) mixing the (a) organic polyisocyanate, the (b) polyol, the (c) compound having an anionic hydrophilic group and at least two active hydrogens, and the (d) polyhydric alcohol, thereafter neutralizing the anionic hydrophilic group in the (c) compound in a known method, and then reacting the (c) compound thus neutralized, the (a) organic polyisocyanate, the (b) polyol, and the (d) polyhydric alcohol. Moreover, the neutralized product of the isocyanate group-terminated prepolymer may be also produced by (iii) reacting the (a) organic polyisocyanate, the (b) polyol, the (c) compound in which the anionic hydrophilic group is a salt of an anionic hydrophilic group, and the (d) polyhydric alcohol.

In the (i) and (ii) production methods, a basic compound used to neutralize the anionic hydrophilic group is not particularly limited, and examples thereof include: amines such as trimethylamine, triethylamine, tri-n-propylamine, tributylamine, N-methyl-diethanol amine, N, N-dimethylmonoethanolamine, N, N-diethylmonoethanolamine, and triethanolamine; hydroxides of alkali metals such as potassium hydroxide and sodium hydroxide; ammonia; and the like. Among these, tertiary amines such as trimethylamine, triethylamine, tri-n-propylamine, and tributylamine are particularly preferable.

For neutralizing the anionic hydrophilic group in the (i) and (ii) production methods, the amount of the basic compound for neutralization used is preferably 0.5 to 1.5 equivalents, more preferably 0.6 to 1.4 equivalents, and particularly preferably 0.7 to 1.3 relative to the anionic hydrophilic group. If the amount of the basic compound for neutralization used is less than the above lower limit, the emulsifiability and the storage stability of the aqueous polyurethane resin tend to decrease. On the other hand, even if the basic compound for neutralization is added in an amount exceeding the above upper limit, the emulsifiability and the storage stability of the aqueous polyurethane resin are not improved further, which is economically unfavorable.

### (Aqueous Polyurethane Resin)

The aqueous polyurethane resin of the present invention is a product (chain-extended product) obtained by chain-extending the neutralized product of the isocyanate group-terminated prepolymer with the (e) polyamine.

### (Emulsification and Dispersion)

For chain-extending the neutralized product of the isocyanate group-terminated prepolymer, first, the neutralized product of the isocyanate group-terminated prepolymer is emulsified and dispersed in water. An emulsifying and dispersing method is not particularly limited, and examples thereof include conventionally known methods using a homomixer, a homogenizer, a disperser, or the like. The neutralized product of the isocyanate group-terminated prepolymer can be emulsified and dispersed in water at a temperature in a range of 0 to 40° C. without particularly adding an emulsifier. In this way, a reaction between the isocyanate groups and water can be inhibited. In addition, for emulsifying and dispersing the neutralized product of the isocyanate group-terminated prepolymer, a reaction inhibitor such as phosphoric acid, sodium dihydrogen phosphate, disodium hydrogen phosphate, p-toluenesulfonic acid, adipic acid, or benzoyl chloride may be added as needed.

### (Chain Extension)

Next, the neutralized product of the isocyanate group-terminated prepolymer thus emulsified and dispersed in the water is chain-extended by using the (e) polyamine to form the aqueous polyurethane resin of the present invention.

The chain extension method is not particularly limited, and a preferred example thereof is a chain extension method by adding the (e) polyamine to the emulsion dispersion of the neutralized product of the isocyanate group-terminated prepolymer or a chain extension method by adding the emulsion dispersion of the neutralized product of the isocyanate group-terminated prepolymer to the (e) polyamine. Under the condition where a reaction temperature is 20 to 50° C., a reaction between the neutralized product of the isocyanate group-terminated prepolymer and the amine is generally completed within 30 to 120 minutes after the neutralized product of the isocyanate group-terminated prepolymer and the (e) polyamine are mixed.

Such chain extension may be performed simultaneously with the emulsification and dispersion, be performed after the emulsification and dispersion, or be performed before the emulsification and dispersion. In the case where the aqueous polyurethane resin obtained contains an organic solvent, it is preferable to remove the organic solvent at a temperature of 30 to 80° C. under reduced pressure.

Note that since the (e) polyamine also has multiple reaction points as in the (a) organic polyisocyanate, the (b) polyol, the (c) compound having an anionic hydrophilic group and at least two active hydrogens, and the (d) polyhydric alcohol, the chain-extended product (aqueous polyurethane resin) of the neutralized product of the isocyanate group-terminated prepolymer obtained by chain-extending the neutralized product of the isocyanate group-terminated prepolymer with such (e) polyamine also has a complicated structure and cannot be directly expressed in a general formula (structural formula), as similar to the foregoing isocyanate group-terminated prepolymer.

The aqueous polyurethane resin of the present invention thus obtained is preferably used in a state emulsified and dispersed in water, and the resin concentration is not particularly limited but is preferably 20 to 608 by mass. The resin concentration in a water-based emulsion dispersion of the aqueous polyurethane resin can be adjusted by adding or removing water.

### [Surface Treatment Agent]

Next, a surface treatment agent of the present invention will be described. The surface treatment agent of the present invention contains an aqueous polyurethane resin that is a chain-extended product of an isocyanate group-terminated prepolymer or a neutralized product thereof in which the isocyanate group-terminated prepolymer is a reaction product of at least (a) an organic polyisocyanate, (b) a polyol, and (d) a polyhydric alcohol, the chain-extended product being obtained by chain-extending the isocyanate group-terminated prepolymer or the neutralized product thereof with (e) a polyamine having two or more amino groups and/or imino groups. Here, the (a) organic polyisocyanate, the (b) polyol, and the (d) polyhydric alcohol used in the surface treatment agent of the present invention are the same as the (a) organic polyisocyanate, the (b) polyol, and the (d) polyhydric alcohol described regarding the aqueous polyurethane resin of the present invention.

Examples of the aqueous polyurethane resin used in the surface treatment agent of the present invention include the aqueous polyurethane resin of the present invention that is a self-emulsifying type of an aqueous polyurethane resin. Instead, a forcibly-emulsified type of an aqueous polyurethane resin, which will be described later, can be also used in the surface treatment agent of the present invention. The forcibly-emulsified type of the aqueous polyurethane resin means an aqueous polyurethane resin of a type (forcibly-emulsified type) which contains no anionic hydrophilic group (such as carboxyl group, carboxylate group, sulfo group, or sulfonate group), does not exhibit self-emulsifiability, requires addition of an emulsifier for emulsification in water, and can be forcibly emulsified with the emulsifier. Here, the term “aqueous” in the forcibly-emulsified type of the aqueous polyurethane resin means a property capable of creating a state in which, even when an emulsion dispersion prepared by emulsifying and dispersing a forcibly-emulsified type of a polyurethane resin in water using an emulsifier such that the resin concentration is 35% by mass in the water is allowed to stand at 20° C. for 12 hours after the preparation, no separation or sedimentation is observed in the emulsion dispersion.

Of these aqueous polyurethane resins, the aqueous polyurethane resin of the present invention that is a self-emulsifying type of an aqueous polyurethane resin is preferable from the viewpoint that surface-treated leather has no stain generated by an emulsifier.

### <Forcibly-Emulsified Type of Aqueous Polyurethane Resin>

The forcibly-emulsified type of the polyurethane resin used in the surface treatment agent of the present invention is a product obtained by chain-extending an isocyanate group-terminated prepolymer which is a reaction product of the (a) organic polyisocyanate, the (b) polyol, and the (d) polyhydric alcohol with the (e) polyamine having two or more amino groups and/or imino groups in a state emulsified and dispersed in water using an emulsifier.

### (Isocyanate Group-Terminated Prepolymer)

The isocyanate group-terminated prepolymer used in the forcibly-emulsified type of the aqueous polyurethane resin is an isocyanate group-terminated prepolymer containing no anionic hydrophilic group, which is a reaction product of the (a) organic polyisocyanate, the (b) polyol, and the (d) polyhydric alcohol.

As a method for producing such an isocyanate group-terminated prepolymer containing no anionic hydrophilic group, it is possible to employ the same method as the method for producing an isocyanate group-terminated prepolymer in the aqueous polyurethane resin of the present invention except that the (c) compound having an anionic hydrophilic group and at least two active hydrogens is not used.

Note that since all of the (a) organic polyisocyanate, the (b) polyol, and the (d) polyhydric alcohol have multiple reaction points, the above isocyanate group-terminated prepolymer containing no anionic hydrophilic group obtained by a reaction of the organic polyisocyanate, the (b) polyol, and the (d) polyhydric alcohol as described above has a complicated structure and cannot be directly expressed in a general formula (structural formula).

### (Method for Producing Forcibly-Emulsified Type of Aqueous Polyurethane Resin)

The forcibly-emulsified type of the aqueous polyurethane resin is obtained in such a way that the isocyanate group-terminated prepolymer containing no anionic hydrophilic group is chain-extended with the (e) polyamine having two or more amino groups and/or imino groups in a state emulsified and dispersed in water by using an emulsifier.

### (Emulsification and Dispersion)

As a method for emulsifying and dispersing the isocyanate group-terminated prepolymer containing no anionic hydrophilic group, it is possible to employ the same method as the method for emulsifying and dispersing the neutralized product of the isocyanate group-terminated prepolymer in the aqueous polyurethane resin of the present invention except that the isocyanate group-terminated prepolymer containing no anionic hydrophilic group is used in place of the neutralized product of the isocyanate group-terminated prepolymer and is emulsified and dispersed in water by using an emulsifier.

As the emulsifier, there are nonionic surfactants and anionic surfactants. Examples of the nonionic surfactants include nonionic surfactants of polyoxyethylene distyryl phenyl ether type, nonionic surfactants of polyoxyethylene propylene distyryl phenyl ether type, nonionic surfactants of polyoxyethylene tristyryl phenyl ether type, nonionic surfactants of polyoxyethylene propylene tristyrylphenyl ether type, and nonionic surfactants of Pluronic (registered trademark) type. Examples of the anionic surfactants include higher alcohol sulfates, higher alkyl ether sulfates, polyalkylene glycol sulfates, polyoxyalkylene aryl ether sulfates, polyoxyalkylene aryl ether phosphates, sulfated oil, sulfated fatty acid esters, alkylbenzene sulfonates, alkylnaphthalene sulfonates, naphthalene sulfonates and their polymers, paraffin sulfonates, dialkyl sulfosuccinates, polystyrene sulfonates, lignosulfonates, and alkyl ether phosphates. These emulsifiers may be used alone or in combination of two or more. However, it is preferable to use at least one of the nonionic surfactants and it is more preferable to use an emulsifier having an HLB of 7 to 16 among the nonionic surfactants from the viewpoints of the storage stability and the processing stability of a water-based dispersion of the forcibly-emulsified type of the aqueous polyurethane resin. In the present invention, a value of HLB is a value obtained in accordance with the following formula:

Molecular weight of oxyethylene group moieties in a nonionic surfactant×20/Molecular weight of the nonionic surfactant.

The amount of the emulsifier added cannot be generalized because it varies depending on the hydrophilicity of the isocyanate group-terminated prepolymer containing no anionic hydrophilic group, but is preferably 0.5 to 10 parts by mass and more preferably 1 to 6 parts by mass with respect to 100 parts by mass of the isocyanate group-terminated prepolymer containing no anionic hydrophilic group. If the amount of the emulsifier added is less than the above lower limit, it tends to be difficult to obtain a sufficiently stable emulsified and dispersed state. On the other hand, if the amount of the emulsifier added exceeds the above upper limit, the obtained aqueous polyurethane resin tends to decrease in water resistance or generate stains on surface-treated leather.

### (Chain Extension)

As a method for chain-extending the isocyanate group-terminated prepolymer containing no anionic hydrophilic group thus emulsified and dispersed in water, it is possible to employ the same method as the method for chain-extending the neutralized product of the isocyanate group-terminated prepolymer in the aqueous polyurethane resin of the present invention except that the isocyanate group-terminated prepolymer containing no anionic hydrophilic group emulsified and dispersed in water by using the emulsifier is used in place of the neutralized product of the isocyanate group-terminated prepolymer emulsified and dispersed in the water.

Note that since the (e) polyamine also has multiple reaction points as in the (a) organic polyisocyanate, the (b) polyol, and the (d) polyhydric alcohol, the chain-extended product of the isocyanate group-terminated prepolymer (the forcibly-emulsified type of the aqueous polyurethane resin) obtained by chain-extending the isocyanate group-terminated prepolymer with such (e) polyamine also has a complicated structure and cannot be directly expressed in a general formula (structural formula), as similar to the foregoing isocyanate group-terminated prepolymer.

The forcibly-emulsified type of the aqueous polyurethane resin thus obtained is preferably used in a state emulsified and dispersed in water, and the resin concentration is not particularly limited but is preferably 20 to 60% by mass. The resin concentration in a water-based emulsion dispersion of the aqueous polyurethane resin can be adjusted by adding or removing water.

### <Surface Treatment Agent>

The surface treatment agent of the present invention contains such an aqueous polyurethane resin (for example, the self-emulsifying type of the aqueous polyurethane resin or the forcibly-emulsified type of the aqueous polyurethane resin, or preferably the self-emulsifying type of the aqueous polyurethane resin). When a surface of a leather base material is treated with such a surface treatment agent, a surface treatment layer is formed on the surface of the leather base material with the surface treatment agent, so that color, luster, texture, touch feeling and so on are adjusted and further the wear resistance is improved.

Moreover, in addition to the aqueous polyurethane resin, the surface treatment agent of the present invention may be blended with a resin other than the aqueous polyurethane resin (such as an acrylic resin or a polyester resin) or various additives to the extent that the effects of the present invention are not impaired. The various additives include matting agent, smoothing agent, thickener, cross-linking agent, surfactant, defoaming agent, leveling agent, viscoelasticity modifier, wetting agent, dispersant, preservative, film-forming agent, plasticizer, penetrating agent, fragrance, bactericide, acaricide, antifungal agent, ultraviolet absorber, antioxidant, antistatic agent, flame retardant, dye, pigment, and the like.

### (Resin)

The resin other than the aqueous polyurethane resin is, for example, an acrylic resin. As acrylic monomers used in the acrylic resin, there are (meth) acrylic acid and derivatives thereof such as methyl (meth) acrylate, ethyl (meth) acrylate, 2-ethylhexyl (meth) acrylate, lauryl (meth) acrylate, stearyl (meth) acrylate, cyclohexyl (meth) acrylate, isobornyl (meth) acrylate, benzyl (meth) acrylate, (meth) acrylic acid, glycidyl (meth) acrylate, dimethylaminoethyl (meth) acrylate, diethylaminoethyl (meth) acrylate, 2-hydroxyethyl (meth) acrylate, and 2-hydroxypropyl (meth) acrylate. Here, the (meth) acrylic acid indicates acrylic acid or methacrylic acid. There acrylic monomers may be used alone or in combination of two or more.

Comonomers used in the acrylic resin include aromatic vinyl compounds such as styrene, α-methylstyrene, and p-methylstyrene; acrylamides such as acrylamide, diacetone acrylamide, methacrylamide and maleic acid amide; heterocyclic vinyl compounds such as vinyl pyrrolidone; vinyl compounds such as vinyl chloride, acrylonitrile, vinyl ether, vinyl ketone, and vinylamide; α-olefins such as ethylene and propylene; maleic acid, fumaric acid, itaconic acid and derivatives thereof, and the like. These comonomers may be used alone or in combination of two or more.

### (Matting Agent)

The surface treatment agent of the present invention may be blended with a matting agent in order to adjust the glossy texture and luster of a leather surface. Examples of such a matting agent include organic beads, silica particles, talc, aluminum hydroxide, calcium sulfate, calcium silicate, calcium carbonate, magnesium carbonate, barium carbonate, alumina silicate, kaolin, mica, and the like. These matting agents may be used alone or in combination of two or more.

Examples of the organic beads include urethane beads, acrylic beads, silicone beads, olefin beads, high-density polyethylene, low-density polyethylene, and the like. Examples of the silica particles include dry silica, wet silica, and the like. Among them, dry silica is preferable from the viewpoints that the scattering effect is high and the gloss value can be adjusted with a small amount. The average particle diameter of the organic beads is preferably 2 to 14 μm and more preferably 3 to 12 μm.

The amount of such a matting agent blended may be an appropriate amount depending on the matte texture (glossy texture or luster) of the leather surface, but is preferably 1 to 150 parts by weight, more preferably 5 to 120 parts by weight, and further preferably 7 to 100 parts by weight with respect to 100 parts by weight of the aqueous polyurethane resin, in general.

### (Smoothing Agent)

The surface treatment agent of the present invention may be blended with a smoothing agent in order to improve the smoothness and wear resistance of a leather surface. Examples of the smoothing agent include polydimethyl silicone, hydrogen-modified silicone, vinyl-modified silicone, epoxy-modified silicone, amino-modified silicone, carboxyl-modified silicone, halogenated-modified silicone, methacryloxy-modified silicone, mercapto-modified silicone, fluorine-modified silicone, alkyl-modified silicone, phenyl-modified silicone, polyether-modified silicone, and the like. These smoothing agents may be used alone or in combination of two or more. Among these smoothing agents, polydimethyl silicone and epoxy-modified silicone are preferable from the viewpoint that the effect of improving the wear resistance is high.

In the surface treatment agent of the present invention, a commercially available product may be used as the smoothing agent. Examples of a commercially available emulsion product of the polydimethyl silicone include DOWSIL SM490EX, DOWSIL SM-8706EX, DOWSIL IE-7046T, DOWSIL FBL-3289, and DOWSIL Q2-3238 (all manufactured by Dow Toray Co., Ltd.), KM-752T, KM-862T, KM-9737A, and POLON MF-33 (all manufactured by Shin-Etsu Chemical Co., Ltd.), and the like. Examples of a commercially available emulsion product of the epoxy-modified silicone include DOWSIL SM-8701 (manufactured by Dow Toray Co., Ltd.), POLON MF-18T and X-51-1264 (both manufactured by Shin-Etsu Chemical Co., Ltd.), and the like.

An amount of such a smoothing agent blended (amount of a non-volatile component blended) may be an appropriate amount depending on the smoothness and the wear resistance of a leather surface, but is preferably 1 to 150 parts by mass, more preferably 5 to 120 parts by mass, and further preferably 7 to 100 parts by mass with respect to 100 parts by mass of the aqueous polyurethane resin, in general.

### (Thickener)

The surface treatment agent of the present invention may be blended with a thickener in order to adjust the viscosity to an appropriate level. Examples of such a thickener include alkali-thickening acrylic resin, associative thickener, water-soluble organic polymer, and the like. These thickeners may be used alone or in combination of two or more.

In the surface treatment agent of the present invention, a commercially available product may be used as the alkali-thickening acrylic resin. Examples of the commercially available product of the alkali-thickening acrylic resin include Nikasol VT-253A (manufactured by Nippon Carbide Industry Co., Ltd.), ARON A-20P, ARON A-7150, ARON A-7070, ARON B-300, ARON B-300K, and ARON B-500 (all manufactured by Toagosei Co., Ltd.), JURYMER AC-10LHP, JURYMER AC-10SHP, RHEOGIC 835H, JUNLON PW-110, and JUNLON PW-150 (all manufactured by Nihon Junyaku Co., Ltd.), Primal ASE-60, Primal TT-615, and Primal RM-5 (all manufactured by Rohm and Haas Japan KK.), SN Thickener A-818 and SN Thickener A-850 (both manufactured by San Nopco Limited), Paragum 500 (manufactured by Parachem Southern Inc.), RHEOLATE 430 (manufactured by Elementis Japan K.K.), Neo Sticker V-420 (manufactured by Nicca Chemical Co., Ltd.), and the like. In general, these alkali-thickening acrylic resins are commercially available as emulsion dispersions of resins and are preferably used in an emulsified and dispersed state.

Also, in the surface treatment agent of the present invention, a commercially available product may be used as the associative thickener. Examples of the commercially available product of the associative thickener include ADEKA NOL UH-450, ADEKA NOL UH-540, and ADEKA NOL UH-752 (all manufactured by Asahi Denka Kogyo Co., Ltd.), SN Thickener 601, SN Thickener 612, SN Thickener 621N, SN Thickener 623N, and SN Thickener 660T (all manufactured by San Nopco Limited), RHEOLATE 244, RHEOLATE 278, and RHEOLATE 300 (all manufactured by Elementis Japan K.K.), DK Thickener SCT-275 (manufactured by DKS Co. Ltd.), and the like.

Examples of the water-soluble organic polymer include natural water-soluble organic polymers, semi-synthetic water-soluble organic polymers, and synthetic water-soluble organic polymers. As the natural water-soluble organic polymers, there are starches such as potato starch, sweet potato starch, wheat starch, rice starch, tapioca starch, and corn starch; resin polysaccharides such as gum arabic, gum tragacanth, gum karaya, and aibika; seaweed polysaccharides such as sodium alginate, carrageenan, agar (galactan), and funori (Gloiopeltis); microbially-fermented polysaccharides such as xanthan gum, pullulan, curdlan, dextrin, and levan; proteins such as casein, gelatin, albumin, glue, and collagen; pectin, chitin, chitosan, and the like.

As the semi-synthetic water-soluble organic polymers, there are cellulose derivatives such as methylcellulose, ethylcellulose, hydroxyethylcellulose, hydroxypropylcellulose, carboxymethylcellulose, and sodium cellulose sulfate; starch derivatives such as dextrin, soluble starch, oxidized starch, carboxymethyl starch, hydroxyethyl starch, hydroxypropyl starch, dialdehyde starch, starch phosphate, and acetyl starch; alginate propylene glycol ester, and the like.

As the synthetic water-soluble organic polymers, there are polyvinyl alcohol, polyacrylic acid, polyacrylate, polyacrylamide, polyvinylpyrrolidone, polyvinyl alkyl ether, maleic anhydride copolymer, maleic acid copolymer, maleate copolymer, and the like.

An amount of such a thickener blended (amount of a non-volatile component blended) may be an appropriate amount depending on the viscosity of the surface treatment agent, but is preferably 0.5 to 40 parts by mass, more preferably 1 to 30 parts by mass, and further preferably 2 to 20 parts by mass with respect to 100 parts by mass of the aqueous polyurethane resin, in general.

### (Cross-Linking Agent)

The surface treatment agent of the present invention may be blended with a cross-linking agent in order to improve the water resistance and durability of leather. As the cross-linking agent, there are carbodiimide-based cross-linking agents, isocyanate-based cross-linking agents, epoxy-based cross-linking agents, oxazoline-based cross-linking agents, aziridine-based cross-linking agents, blocked isocyanate-based cross-linking agents, water-dispersed isocyanate-based cross-linking agents, and melamine-based cross-linking agents, and the like. These cross-linking agents may be used alone or in combination of two or more. In addition, these cross-linking agents can be blended regardless of whether the aqueous polyurethane resin contained in the surface treatment agent of the present invention is of the self-emulsifying type or the forcibly-emulsified type. In the case of a self-emulsifying type of aqueous polyurethane resin having a carboxyl group, however, it is particularly preferable to blend a carbodiimide-based cross-linking agent among these cross-linking agents from the viewpoints of the texture and the stability of a treatment solution.

In the surface treatment agent of the present invention, a commercially available product may be used as such a cross-linking agent. Examples of a commercially available product of the carbodiimide-based cross-linking agent include CARBODILITE E-02, CARBODILITE SV-02, CARBODILITE V02-L2, and CARBODILITE V-10 (all manufactured by Nisshinbo Chemical Inc.), NK ASSIST CI-02 (manufactured by Nicca Chemical Co., Ltd.), and the like.

From the viewpoints of the wear resistance and flex resistance of leather, an amount of such a cross-linking agent blended (amount of a non-volatile component blended) is preferably 1 to 15 parts by mass and more preferably 2 to 10 parts by mass with respective to 100 parts by mass of the aqueous polyurethane resin.

### [Leather]

Leather of the present invention comprises a leather base material and a surface treatment layer formed on a surface of the base material with the surface treatment agent of the present invention. Such leather products include vehicle interior materials, motorcycle seats and grips, sports shoes, clothing, furniture, and so on using synthetic leather, artificial leather, natural leather, or polyvinyl chloride (PVC) leather.

As the leather base material, there are synthetic leather including a skin layer made of polyurethane resin (PU), polyvinyl chloride (PVC) leather, and pseudo-leather made of thermoplastic polyurethan elastomer (TPU) and the like.

A method for forming the surface treatment layer on a surface of a leather base material is not particularly limited. For example, the surface treatment layer can be formed by applying the surface treatment agent onto the surface of the leather base material and then drying the agent.

Examples of a method for applying the surface treatment agent include: a method for applying the surface treatment agent onto the surface of the leather base material by using any of various coaters such as a gravure coater, a bar coater, a comma coater, a blade coater, and an air knife coater; a method for spraying the surface treatment agent onto the surface of the leather base material; a method for immersing the leather base material into the surface treatment agent; and the like. Among them, a direct coating method and a reverse coating method using a gravure coater are more preferable. A coating amount of the surface treatment agent is preferably such that the amount of the applied agent after drying is preferably 4 to 40 g/m² and more preferably 6 to 30 g/m².

A method for drying the surface treatment agent applied is not particularly limited. For example, the surface treatment agent is preferably dried at a temperature in a range of 40 to 160° C. for 30 seconds to 10 minutes, or is more preferably dried at a temperature in a range of 80 to 130° C. for 30 seconds to 2 minutes. Then, after the drying, it is preferable to perform an aging treatment at a temperature in a range of 20 to 100° C. for 5 to 72 hours.

### EXAMPLES

Hereinafter, the present invention will be described more specifically on the basis of Examples and Comparative Examples; however, the present invention should not be not limited to Examples below. The content of free isocyanate groups in each synthesis example was measured in the following method.

### (Content of Free Isocyanate Groups)

In an Erlenmeyer flask, 0.3 g of urethane prepolymer was placed and then dissolved with addition of 10 ml of 0.1N dibutylamine toluene solution. Next, several drops of bromophenol blue solution were added, titration was carried out with 0.1N hydrochloric acid methanol solution, and the content of free isocyanate groups NCO % was determined in accordance with the following formula:

$$NCO \% = ( a - b ) \times 0.42 \times f / x$$

(wherein, a: a titer of 0.1N hydrochloric acid methanol solution when only 10 ml of 0.1N dibutylamine toluene solution was titrated, b: a titer of 0.1N hydrochloric acid methanol solution when a solution in which the urethane prepolymer was dissolved was titrated, f: a factor of 0.1N hydrochloric acid methanol solution, and x: an amount of urethane prepolymer).

The raw materials used in the synthesis examples are listed below.

### <Organic Polyisocyanate>

H12MDI: Dicyclohexylmethane 4,4′-diisocyanate (“Desmodur W” manufactured by Covestro AG).
IPDI: Isophorone diisocyanate (“VESTANAT (R) IPDI” manufactured by Evonik Japan Co., Ltd.).
1,5-PDI: 1,5-Pentamethylene diisocyanate.
HDI: Hexamethylene diisocyanate.
MDI: Diphenylmethane diisocyanate.

### <Polyol>

T5652: Polycarbonate diol (1,5-pentanediol/1,6-hexanediol) manufactured by Asahi Kasei Chemicals Corporation, trade name “DURANOL T5652”, weight average molecular weight 2000.
T5651: Polycarbonate diol (1,5-pentanediol/1,6-hexanediol) manufactured by Asahi Kasei Chemicals Corporation, trade name “DURANOL T5651”, weight average molecular weight 1000.
C2090: Polycarbonate diol (3-methyl-1,5-pentanediol/1,6-hexanediol) manufactured by Kuraray Co., Ltd., trade name “Kuraray polyol C-2090”, weight average molecular weight 2000.
UP200: Polycarbonate diol (2-methyl-1,3-propanediol) manufactured by Ube Industries, Ltd., trade name “ETERNACOLL UP-200”, weight average molecular weight 2000.

HS PD2003: Polycarbonate diol (1,3-propanediol)
manufactured by Hokoku Corporation, trade name “HS PD-2003”, weight average molecular weight 2000.
NL2010 DB: Polycarbonate diol (1,4-butanediol/1,10-decanediol) manufactured by Mitsubishi Chemical Corporation, trade name “BENEBIOL NL-2010 DB”, weight average molecular weight 2000.
T6002: Polycarbonate diol (1,6-hexanediol) manufactured by Asahi Kasei Chemicals Corporation, trade name “DURANOL T6002”, weight average molecular weight 2000.
T6001: Polycarbonate diol (1,6-hexanediol) manufactured by Asahi Kasei Chemicals Corporation, trade name “DURANOL T6001”, weight average molecular weight 1000.
T4692: Polycarbonate diol (1,4-butanediol/1,6-hexanediol) manufactured by Asahi Kasei Chemicals Corporation, trade name “DURANOL T4692”, weight average molecular weight 2000.
PTMG2000: Poly(tetramethylene ether) glycol manufacture by Mitsubishi Chemical Corporation, trade name “PTMG2000”, average molecular weight 2000.
1,3-BD: 1,3-Butanediol.

### <Trihydric or Higher Polyhydric Alcohol>

TMP: Trimethylolpropane.

### <Anionic Hydrophilic Group/Active Hydrogen-Containing Compound>

DMPA: Dimethylolpropionic acid.

### <Neutralized Amine>

TEA: Triethylamine.

### <Chain Extender>

EDA: Ethylenediamine.
DETA: Diethylenetriamine.

The aqueous polyurethane resin used in Examples and Comparative Examples was synthesized in accordance with the following method.

### Synthesis Example 1

In a four-necked flask equipped with a stirrer, a reflux condenser, a thermometer, and a nitrogen blowing tube, 71.7 parts by mass of polycarbonate diol (1,5-pentanediol/1,6-hexanediol) (“DURANOL T5652” manufactured by Asahi Kasei Chemicals Corporation, number average molecular weight 2000) as the (b1) polycarbonate diol, 0.4 parts by mass of trimethylolpropane as the (d) polyhydric alcohol, 3.1 parts by mass of dimethylolpropionic acid as the (c) anionic hydrophilic group/active hydrogen-containing compound, and 42.2 parts by mass of methyl ethyl ketone were charged and uniformly mixed, and then 23.5 parts by mass of dicyclohexylmethane diisocyanate as the (a) organic polyisocyanate and 0.03 parts by mass of bismath tris(2-ethylhexanoate) were added, followed by reaction at 80° C. for 240 minutes to obtain a methyl ethyl ketone solution of isocyanate group-terminated urethane prepolymer having a content of free isocyanate groups of 2.29% by mass based on the isocyanate group-terminated prepolymer.

To this solution, 2.2 parts by mass of triethylamine was added, and the mixture was uniformly mixed and then was emulsified and dispersed by gradually adding 185 parts by mass of water. To the obtained emulsion dispersion, 1.1 parts by mass of hydrazine monohydrate and 0.4 parts by mass of diethylenetriamine were added as (e) chain extenders, followed by stirring for 90 minutes to obtain a polyurethane dispersion. Subsequently, this polyurethane dispersion was desolvated at 40° C. under reduced pressure to obtain a stable water-based dispersion of an aqueous polyurethane resin with a resin content of 35.0% by mass, a viscosity of 50 mPa's and an average particle diameter of 0.1 μm.

Table 1 shows the following features in the obtained water-based dispersion of the aqueous polyurethane resin, including: the ratio of the total amount of the polycarbonate diols (b1) and (b2) to the total amount of the (b) polyol; the ratio of the (d) polyhydric alcohol to the total amount of the (b) polyol, the (c) anionic hydrophilic group/active hydrogen-containing compound, and the (d) polyhydric alcohol; the content of free isocyanate groups in the isocyanate group-terminated urethane prepolymer; the content of anionic hydrophilic group in the aqueous polyurethane resin; the particle diameter of the aqueous polyurethane resin, and the viscosity of the water-based dispersion of the aqueous polyurethane resin.

### Synthesis Examples 2 to 19 and Comparative Synthesis Examples 1 to 7

Water-based dispersions of aqueous polyurethane resins (the resin content of 35.0% by mass) were obtained in the same manner as in Synthesis Example 1 except that the types and amounts of the organic polyisocyanate, the polyol, the polyhydric alcohol, the anionic hydrophilic group-containing polyol, the neutralized amine, and the chain extenders shown in Tables 1 to 3 were used. Tables 1 to 3 show the following features in each of in the obtained water-based dispersions of the aqueous polyurethane resins, including: the ratio of the total amount of the polycarbonate diols (b1) and (b2) to the total amount of the (b) polyol; the ratio of the (d) polyhydric alcohol to the total amount of the (b) polyol, the (c) anionic hydrophilic group/active hydrogen-containing compound, and the (d) polyhydric alcohol; the content of free isocyanate groups in the isocyanate group-terminated urethane prepolymer; the content of anionic hydrophilic group in the aqueous polyurethane resin; the particle diameter of the aqueous polyurethane resin, and the viscosity of the water-based dispersion of the aqueous polyurethane resin.

### Example 1

A water-based surface treatment agent was prepared by uniformly mixing, with a disper, 286 parts by mass of the water-based dispersion of the aqueous polyurethane resin (the resin content 35% by mass) obtained in Synthesis Example 1; as matting agents, 7 parts by mass of silica particles manufactured by a dry method (“ACEMATT TS 100” manufactured by Evonik Degussa GmbH, average particle diameter: 10 μm) and 30 parts by mass of urethane beads (“ART PEARL P-800T” manufactured by Negami chemical industrial Co., Ltd., average particle diameter: 6 μm, Tg=−34° C.); 40 parts by mass of a smoothing agent (“KM-862T” manufactured by Shin-Etsu Chemical Co., Ltd., non-volatile content 60% by mass); 12 parts by mass of an associative thickener (“SN Thickener 612” manufactured by San Nopco Limited, non-volatile content 40% by mass); 343 parts by mass of ion-exchanged water; and 12 parts by mass of a water-dispersible carbodiimide-based cross-linking agent (“CARBODILITE SV-02” manufactured by Nisshinbo Chemical Inc., non-volatile content 40% by mass).

### Examples 2 to 19 and Comparative Examples 1 to 7

Water-based surface treatment agents were prepared in the same manner as in Example 1 except that the water-based dispersions of the aqueous polyurethane resins (the resin content 35% by mass) obtained in Synthesis Examples 2 to 19 and Comparative Synthesis Examples 1 to 7 were used in an amount of 286 parts by mass in place of the water-based dispersion of the aqueous polyurethane resin obtained in Synthesis Example 1.

### <Production of Leather Base Material>

A coating material for skin layer was applied to a release paper (“Asahi Release AR-148” manufactured by Asahi Roll Co., Ltd.) with a coating thickness of 100 μm (WET coating amount). In the coating material, 100 parts by mass of an aqueous polyurethane resin (“EVAFANOL HA-68” manufactured by Nicca Chemical Co., Ltd., non-volatile content 35% by mass), 10 parts by mass of water-based pigment (“PSM Black C” manufactured by Mikuni-Color, Limited, non-volatile content 31.5% by mass), 1 part by mass of a water-dispersible carbodiimide-based cross-linking agent (“NK ASSIST CI-02” manufactured by Nicca Chemical Co., Ltd., non-volatile content 40% by mass), and 3 parts by mass of an associative thickener (“Neo Sticker S” manufactured by Nicca Chemical Co., Ltd.) were blended. Using a dryer, the coating material was pre-dried at 80° C. for 2 minutes, and then dried at 120° C. for 3 minutes to completely evaporate the moisture content, thereby obtaining a polyurethane resin film (hereinafter referred to as “skin layer”).

On this skin layer, a polyurethane adhesive mixture liquid blended with: 100 parts by mass of two-component aqueous polyurethane resin (“EVAFANOL HO-38” manufactured by Nicca Chemical Co., Ltd., main adhesive agent, non-volatile content 35% by mass); 7 parts by mass of an aqueous polyisocyanate-based curing agent (“NK ASSIST NY-27” manufactured by Nicca Chemical Co., Ltd., non-volatile content 100% by mass); and 5 parts by mass of an associative thickener (“Neo Sticker N” manufactured by Nicca Chemical Co., Ltd., non-volatile content 30% by mass) was applied with a coating thickness of 200 μm (WET coating amount).

Subsequently, the resultant skin layer was dried at 90° C. for one minute using the dryer, and immediately after the drying, a polyester knit was bonded thereon as a fiber base material. After that, the resultant laminate was cured at 120° C. for 3 minutes and then aged at 40° C. for 72 hours. The release paper was peeled off to obtain a fiber laminate (base material for evaluation).

### <Production of Leather>

The skin layer of the obtained fiber laminate was coated with the water-based surface treatment agent obtained in each of Examples and Comparative Examples by using a 100-mesh gravure coater such that the amount of the applied agent after drying was 10 to 20 g/m², and then was dried with hot air at 125° C. for 3 minutes to produce leather for evaluation having a surface treatment layer. The wear resistance and flex resistance of this leather for evaluation were evaluated in the following ways.

### (Wear Resistance)

The obtained leather for evaluation was cut into a test sample of about 10 mm in length and about 10 mm in width, and a 4 mm thick urethane foam (“ER-4” manufactured by INOAC CORPORATION) was attached to the fiber base material on the back side of the test sample with a double-sided tape. The resultant test sample was set on a rubbing element of a Gakushin-type rubbing tester, while a No. 6 cotton canvas was set on a table side of the tester. The rubbing test was conducted under application of a load of 9.8 N. Change in the appearance of the surface treatment layer was observed, and a rubbing count until the surface treatment layer was torn and the fiber base material on the back surface was exposed was measured. Tables 1 to 3 show the obtained results. The rubbing count was defined such that one reciprocation was counted as one rubbing, and the greater the rubbing count, the better the wear resistance.

### (Flex Resistance)

The obtained leather for evaluation was cut into a test sample of about 10 mm in length and about 10 mm in width. The test sample was folded in four with the surface treatment layer facing inward, and was left for 24 hours with a weight of 10 kg placed on a center portion of the folded leather (test of whitening on bending). After this test (10 kg×24 hours), peeling (cracking) and whitening of the surface treatment layer were visually checked, and the flex resistance was evaluated according to the following criteria. Tables 1 to 3 show the obtained results.

### <Evaluation Criteria>

Grade 5: No cracking and whitening was observed on the surface treatment layer of the bent portion.
Grade 4: Whitening was partially observed on the surface treatment layer of the bent portion (less than 20% of the whole).
Grade 3: Whitening was entirely observed (20% or more of the whole), but no cracking/peeling was observed on the surface treatment layer of the bent portion.
Grade 2: Whitening was entirely observed, and cracking/peeling was partially observed (less than 70% of the whole) on the surface treatment layer of the bent portion.
Grade 1: Cracking/peeling was observed over the surface treatment layer of the bent portion (70% or more of the whole).

TABLE 1

| | | | Example | | | | |
|---|---|---|---|---|---|---|---|
| | | | 1 | 2 | 3 | 4 | 5 |
| | | | Synthesis Example | | | | |
| | | MW | 1 | 2 | 3 | 4 | 5 |
| (a) Organic Polyisocyanate | H12MDI | 262 | 23.5 | 32.7 | 23.5 | 23.5 | 23.5 |
| | IPDI | 222.3 | | | | | |
| | 1,5-PDI | 154.2 | | | | | |
| | HDI | 168.2 | | | | | |
| | MDI | 250 | | | | | |
| (b2) Polycarbonate Diol | T5652 | 2000 | 71.7 | | | | |
| | T5651 | 1000 | | 61.9 | | | |
| (b1) Polycarbonate Diol | C2090 | 2000 | | | 71. | | |
| | UP200 | 2000 | | | | 71.7 | |
| (b2) Polycarbonate Diol | HS PD2003 | 2000 | | | | | 71.7 |
| Other Polycarbonate Diol | NL2010DB | 2000 | | | | | |
| | T6002 | 2000 | | | | | |
| | T6001 | 1000 | | | | | |
| | T4692 | 2000 | | | | | |
| Polyether Polyol | PTMG2000 | 2000 | | | | | |
| (d)Polyhydric Alcohol | TMP | 134 | 0.4 | 0.2 | 0.4 | 0.4 | 0.4 |
| Short Chain Diol | 1,3-BD | 90 | | | | | |
| (c) Compound | DMPA | 134 | 3.1 | 3.1 | 3.1 | 3.1 | 3.1 |
| Neutralized Amine | TEA | 101 | 2.2 | 2.2 | 2.2 | 2.2 | 2.2 |
| (e) Chain Extender | Hydrazine Monohydrate | 50 | 1.1 | 1.5 | 1.1 | 1.1 | 1.1 |
| | EDA | 60.1 | | | | | |
| | DETA | 103 | 0.4 | 0.5 | 0.4 | 0.4 | 0.4 |
| Aqueous | Ratio of (b1) + (b2) | mass % | 100.0 | 100.0 | 100.0 | 100.0 | 100.0 |
| Polyurethane Resin | Ratio of (d) | mass % | 0.53 | 0.31 | 0.53 | 0.53 | 0.53 |
| | NCO Content | mass % | 2.29 | 3.21 | 2.29 | 2.29 | 2.29 |
| | Anionic Group Content | mass % | 1.0 | 1.0 | 1.0 | 1.0 | 1.0 |
| | Particle Diameter | μm | 0.1 | 0.1 | 0.1 | 0.1 | 0.1 |
| | Viscosity | mPa · s | 50 | 20 | 40 | 50 | 50 |
| Wear Resistance [Count] | | | 35000 | 45000 | 30000 | 35000 | 40000 |
| Flex Resistance [Grade] | | | 5 | 4 | 5 | 4 | 4 |
| | | | Example | | | | |
| | | | 6 | 7 | 8 | 9 | 10 |
| | | | Synthesis Example | | | | |
| | | MW | 6 | 7 | 8 | 9 | 10 |
| (a) Organic Polyisocyanate | H12MDI | 262 | 23.5 | 24.8 | 22.7 | 21.2 | 22.3 |
| | IPDI | 222.3 | | | | | |
| | 1,5-PDI | 154.2 | | | | | |
| | HDI | 168.2 | | | | | |
| | MDI | 250 | | | | | |
| (b2) Polycarbonate Diol | T5652 | 2000 | 35.8 | 69.9 | 72.7 | 74.4 | 73.1 |
| | T5651 | 1000 | | | | | |
| (b1) Polycarbonate Diol | C2090 | 2000 | | | | | |
| | UP200 | 2000 | | | | | |
| (b2) Polycarbonate Diol | HS PD2003 | 2000 | | | | | |
| Other Polycarbonate Diol | NL2010DB | 2000 | | | | | |
| | T6002 | 2000 | 35.8 | | | | |
| | T6001 | 1000 | | | | | |
| | T4692 | 2000 | | | | | |
| Polyether Polyol | PTMG2000 | 2000 | | | | | |
| (d)Polyhydric Alcohol | TMP | 134 | 0.4 | 0.8 | 0.1 | 0.4 | 0.4 |
| Short Chain Diol | 1,3-BD | 90 | | | | | |
| (c) Compound | DMPA | 134 | 3.1 | 3.0 | 3.1 | 3.1 | 3.1 |
| Neutralized Amine | TEA | 101 | 2.2 | 2.2 | 2.2 | 2.2 | 2.2 |
| (e) Chain Extender | Hydrazine Monohydrate | 50 | 1.1 | 1.1 | 1.0 | 0.6 | 0.8 |
| | EDA | 60.1 | | | | | |
| | DETA | 103 | 0.4 | 0.4 | 0.4 | 0.3 | 0.4 |
| Aqueous | Ratio of (b1) + (b2) | mass % | 50.0 | 100.0 | 100.0 | 100.0 | 00.0 |
| Polyurethane Resin | Ratio of (d) | mass % | 0.53 | 1.09 | 0.13 | 0.51 | 0.52 |
| | NCO Content | mass % | 2.29 | 2.42 | 2.21 | 1.37 | 1.81 |
| | Anionic Group Content | mass % | 1.0 | 1.0 | 1.0 | 1.0 | 1.0 |
| | Particle Diameter | μm | 0.2 | 0.1 | 0.1 | 0.2 | 0.1 |
| | Viscosity | mPa · s | 30 | 30 | 30 | 30 | 50 |

| | | | | | |
|---|---|---|---|---|---|
| Wear Resistance [Count] | 35000 | 40000 | 30000 | 30000 | 35000 |
| Flex Resistance [Grade] | 4 | 4 | 5 | 5 | 5 |

TABLE 2

| | | | Example | | | | |
|---|---|---|---|---|---|---|---|
| | | | 11 | 12 | 13 | 14 | 15 |
| | | | Synthesis Example | | | | |
| | | MW | 11 | 12 | 13 | 14 | 15 |
| (a) Organic Polyisocyanate | H12MDI | 262 | 24.8 | 20.2 | | | 19.0 |
| | IPDI | 222.3 | | | | 20.3 | |
| | 1,5-PDI | 154.2 | | | | | |
| | HDI | 168.2 | | | 16.1 | | |
| | MDI | 250 | | | | | |
| (b2) Polycarbonate Diol | T5652 | 2000 | 70.0 | 75.6 | 78.8 | 74.9 | 77.0 |
| | T5651 | 1000 | | | | | |
| (b1) Polycarbonate Diol | C2090 | 2000 | | | | | |
| | UP200 | 2000 | | | | | |
| (b2) Polycarbonate Diol | HS PD2003 | 2000 | | | | | |
| Other Polycarbonate Diol | NL2010DB | 2000 | | | | | |
| | T6002 | 2000 | | | | | |
| | T6001 | 1000 | | | | | |
| | T4692 | 2000 | | | | | |
| Polyether Polyol | PTMG2000 | 2000 | | | | | |
| (d) Polyhydric Alcohol | TMP | 134 | 0.3 | 0.4 | 0.4 | 0.4 | 0.4 |
| Short Chain Diol | 1,3-BD | 90 | | | | | |
| (c) Compound | DMPA | 134 | 3.1 | 3.1 | 3.2 | 3.0 | 3.0 |
| Neutralized Amine | TEA | 101 | 2.2 | 2.2 | 2.3 | 2.2 | 2.2 |
| (e) Chain Extender | Hydrazine Monohydrate | 50 | 1.4 | 0.4 | 1.2 | 1.1 | 0.2 |
| | EDA | 60.1 | | | | | |
| | DETA | 103 | 0.4 | 0.3 | 0.4 | 0.4 | 0.3 |
| Aqueous | Ratio of (b1) + (b2) | mass % | 100.0 | 100.0 | 100.0 | 100.0 | 100.0 |
| Polyurethane Resin | Ratio of (d) | mass % | 0.41 | 0.51 | 0.49 | 0.51 | 0.50 |
| | NCO Content | mass % | 2.84 | 0.98 | 2.46 | 2.33 | 0.61 |
| | Anionic Group Content | mass % | 1.0 | 1.0 | 1.1 | 1.0 | 1.0 |
| | Particle Diameter | μm | 0.1 | 0.2 | 0.1 | 0.1 | 0.1 |
| | Viscosity | mPa · s | 60 | 30 | 30 | 30 | 30 |

| | | | | | |
|---|---|---|---|---|---|
| Wear Resistance [Count] | 40000 | 30000 | 30000 | 30000 | 30000 |
| Flex Resistance [Grade] | 4 | 5 | 5 | 5 | 5 |

| | | | Example | | | |
|---|---|---|---|---|---|---|
| | | | 16 | 17 | 18 | 19 |
| | | | Synthesis Example | | | |
| | | MW | 16 | 17 | 18 | 19 |
| (a) Organic Polyisocyanate | H12MDI | 262 | 27.4 | 19.8 | 33.5 | 11.8 |
| | IPDI | 222.3 | | | | |
| | 1,5-PDI | 154.2 | | | | |
| | HDI | 168.2 | | | | |
| | MDI | 250 | | | | 11.3 |
| (b2) Polycarbonate Diol | T5652 | 2000 | 67.0 | 77.2 | 56.3 | 72.1 |
| | T5651 | 1000 | | | | |
| (b1) Polycarbonate Diol | C2090 | 2000 | | | | |
| | UP200 | 2000 | | | | |
| (b2) Polycarbonate Diol | HS PD2003 | 2000 | | | | |
| Other Polycarbonate Diol | NL2010DB | 2000 | | | | |
| | T6002 | 2000 | | | | |
| | T6001 | 1000 | | | | |
| | T4692 | 2000 | | | | |
| Polyether Polyol | PTMG2000 | 2000 | | | | |
| (d) Polyhydric Alcohol | TMP | 134 | 0.3 | 0.4 | 0.2 | 0.4 |
| Short Chain Diol | 1,3-BD | 90 | | | | |
| (c) Compound | DMPA | 134 | 3.0 | 1.3 | 7.9 | 3.1 |
| Neutralized Amine | TEA | 101 | 2.2 | 0.9 | 5.6 | 2.2 |
| (e) Chain Extender | Hydrazine Monohydrate | 50 | 1.9 | 0.9 | 1.5 | 1.1 |
| | EDA | 60.1 | | | | |
| | DETA | 103 | 0.4 | 0.3 | 0.5 | 0.4 |
| Aqueous | Ratio of (b1) + (b2) | mass % | 100.0 | 100.0 | 100.0 | 100.0 |
| Polyurethane Resin | Ratio of (d) | mass % | 0.43 | 0.51 | 0.31 | 0.53 |
| | NCO Content | mass % | 3.87 | 1.93 | 3.29 | 1.61 |
| | Anionic Group Content | mass % | 1.0 | 0.4 | 2.6 | 1.0 |
| | Particle Diameter | μm | 0.1 | 0.3 | 0.1 | 0.2 |
| | Viscosity | mPa · s | 30 | 20 | 100 | 50 |

| | | | | |
|---|---|---|---|---|
| Wear Resistance [Count] | 40000 | 35000 | 35000 | 40000 |
| Flex Resistance [Grade] | 4 | 5 | 4 | 4 |

TABLE 3

| | | | Comparative Example | | | | | | |
|---|---|---|---|---|---|---|---|---|---|
| | | | | 2 | 3 | 4 | 5 | 6 | 7 |
| | | | Comparative Synthesis Example | | | | | | |
| | | MW | 1 | 2 | 3 | 4 | 5 | 6 | 7 |
| (a) Organic Polyisocyana | H12MDI | 262 | | 23.5 | 23.5 | 23.5 | 23.5 | 22.3 | 34.6 |
| | IPDI | 222.3 | 15.5 | | | | | | |
| | 1,5-PDI | 154.2 | 2.7 | | | | | | |
| | HDI | 168.2 | | | | | | | |
| | MDI | 250 | | | | | | | |
| (b2) Polycarbonate Diol | T5652 | 2000 | | | | | | 73.2 | |
| | T5651 | 1000 | | | | | | | |
| (b1) Polycarbonate Diol | C2090 | 2000 | | | | | | | |
| | UP200 | 2000 | | | | | | | |
| (b2) Polycarbonate Diol | HS PD2003 | 2000 | | | | | | | |
| Other Polycarbonate Dio | NL2010DB | 2000 | 77.5 | 71.7 | | | | | |
| | T6002 | 2000 | | | 71.7 | | | | |
| | T6001 | 1000 | | | | | | | 58.7 |
| | T4692 | 2000 | | | | 71.7 | | | |
| Polyether Polyol | PTMG2000 | 2000 | | | | | 71.7 | | |
| (d)Polyhydric Alcohol | TMP | 134 | | 0.4 | 0.4 | 0.4 | 0.4 | | |
| Short Chain Diol | 1,3-BD | 90 | 0.4 | | | | | | |
| (c) Compound | DMPA | 134 | 2.5 | 3.1 | 3.1 | 3.1 | 3.1 | 3.1 | 4.0 |
| Neutralized Amine | TEA | 101 | 1.9 | 2.2 | 2.2 | 2.2 | 2.2 | 2.2 | 2.9 |
| (e) Chain Extender | Hydrazine Monohydrate | 50 | | 1.1 | 1.1 | 1.1 | 1.1 | 1.0 | |
| | EDA | 60.1 | 1.5 | | | | | | 2.7 |
| | DETA | 103 | | 0.4 | 0.4 | 0.4 | 0.4 | 0.4 | |
| Aqueous | Ratio of (b1) + (b2) | mass % | 0.0 | 0.0 | 0.0 | 0.0 | 0.0 | 100.0 | 0.0 |
| Polyurethane Resin | Ratio of (d) | mass % | 0.00 | 0.53 | 0.53 | 0.53 | 0.53 | 0.00 | 0.00 |
| | NCO Content | mass % | 2.12 | 2.29 | 2.29 | 2.29 | 2.29 | 2.18 | 3.78 |
| | Anionic Group Content | mass % | 0.9 | 1.0 | 1.0 | 1.0 | 1.0 | 1.0 | 1.3 |
| | Particle Diameter | μm | 0.1 | 0.2 | 0.2 | 0.1 | 0.1 | 0.1 | 0.1 |
| | Viscosity | mPa · s | 20 | 50 | 30 | 50 | 50 | 50 | 20 |

| | | | | | | | |
|---|---|---|---|---|---|---|---|
| Wear Resistance [Count] | 20000 | 35000 | 40000 | 40000 | 20000 | 25000 | 40000 |
| Flex Resistance [Grade] | 3 | 3 | 3 | 3 | 5 | 5 | 2 |

As shown in Tables 1 to 3, it was found that the leather having excellent wear resistance was obtained without the flexibility impaired when the leather base material was surface-treated by using the surface treatment agent containing the aqueous polyurethane resin synthesized by using the (b1) polycarbonate diol having a structural unit derived from a diol having a branched structure with an integer of 3 to 10 carbon atoms (Example 3) or the (b2) polycarbonate diol having a structural unit derived from a diol having a linear structure with an odd number of 3 to 9 carbon atoms (each of Examples 1 to 2 and 4 to 19) as the (b) polyol, and using the (d) trihydric or higher polyhydric alcohol.

On the other hand, it was found that, when the other polycarbonate diol was used in place of the (b1) polycarbonate diol and the (b2) polycarbonate diol and a short chain diol was used in place of the (d) trihydric or higher polyhydric alcohol (Comparative Example 1), the flexibility was impaired and the wear resistance was also deteriorated.

Further, it was found that, when the other polycarbonate diol was used in place of the (b1) polycarbonate diol and the (b2) polycarbonate diol, the excellent wear resistance was obtained but the flexibility was impaired irrespective of whether the (d) trihydric or higher polyhydric alcohol was used (Comparative Examples 2 to 4) or was not used (Comparative Example 7).

Furthermore, it was found that the flexibility was not impaired but the wear resistance was deteriorated when the polyether polyol was used in place of the (b1) polycarbonate diol and the (b2) polycarbonate diol even while the (d) trihydric or higher polyhydric alcohol was used (Comparative Example 5), and when the (d) trihydric or higher polyhydric alcohol was not used even while the (b2) polycarbonate diol was used (Comparative Example 6).

### INDUSTRIAL APPLICABILITY

As described above, according to the present invention, it is possible to obtain leather to which wear resistance is imparted without impairing flexibility. Therefore, leathers of the present invention are preferably usable in various industrial fields such as vehicles, furniture, clothing, bags, shoes, sacks, and groceries, and moreover are suitably usable as stable and high-quality leather products when provided with surface treatment layers.

1. An aqueous polyurethane resin that is a chain-extended product of a neutralized product of an isocyanate group-terminated prepolymer which is a reaction product of (a) an organic polyisocyanate, (b) a polyol, (c) a compound having an anionic hydrophilic group and at least two active hydrogens, and (d) a polyhydric alcohol, the chain-extended product being obtained by chain-extending the neutralized product with (e) a polyamine having two or more amino groups and/or imino groups, wherein
the (b) polyol contains at least one selected from the group consisting of (b1) polycarbonate diols each having a structural unit derived from a diol having a branched structure with an integer of 3 to 10 carbon atoms and (b2) polycarbonate diols each having a structural unit derived from a diol having a linear structure with an odd number of 3 to 9 carbon atoms, and
the (d) polyhydric alcohol contains a polyhydric alcohol having at least three or more active hydrogens.

2. The aqueous polyurethane resin according to claim 1, wherein
the (b1) polycarbonate diol is a polycarbonate diol having the structural unit derived from the diol having the branched structure with an integer of 3 to 10 carbon atoms and a structural unit derived from a diol having a linear structure with an integer of 3 to 10 carbon atoms, and
the (b2) polycarbonate diol is at least one selected from the group consisting of a polycarbonate diol having the structural unit derived from the diol having the linear structure with an odd number of 3 to 9 carbon atoms and a structural unit derived from a diol having a linear structure with an even number of 4 to 10 carbon atoms and a polycarbonate diol having a structural unit derived from only the diol having the linear structure with an odd number of 3 to 9 carbon atoms.

3. The aqueous polyurethane resin according to claim 1, wherein
a ratio of a total amount of the polycarbonate diols (b1) and (b2) in the (b) polyol is 40% by mass or more.

4. The aqueous polyurethane resin according to claim 1, wherein
a ratio of the (d) polyhydric alcohol to a total amount of the (b) polyol, the (c) compound having an anionic hydrophilic group and at least two active hydrogens, and the (d) polyhydric alcohol is 0.1 to 1.5% by mass.

5. The aqueous polyurethane resin according to claim 1, wherein
a content of free isocyanate groups in the isocyanate group-terminated prepolymer is 0.2 to 4.0% by mass.

6. The aqueous polyurethane resin according to claim 1, wherein
the (a) organic polyisocyanate is at least one selected from the group consisting of aliphatic polyisocyanates and alicyclic polyisocyanates.

7. A surface treatment agent comprising an aqueous polyurethane resin that is a chain-extended product of an isocyanate group-terminated prepolymer or a neutralized product thereof in which the isocyanate group-terminated prepolymer is a reaction product of at least (a) an organic polyisocyanate, (b) a polyol, and (d) a polyhydric alcohol, the chain-extended product being obtained by chain-extending the isocyanate group-terminated prepolymer or the neutralized product thereof with (e) a polyamine having two or more amino groups and/or imino groups, wherein
the (b) polyol contains at least one selected from the group consisting of (b1) polycarbonate diols each having a structural unit derived from a diol having a branched structure with an integer of 3 to 10 carbon atoms and (b2) polycarbonate diols each having a structural unit derived from a diol having a linear structure with an odd number of 3 to 9 carbon atoms, and
the (d) polyhydric alcohol contains a polyhydric alcohol having at least three or more active hydrogens.

8. The surface treatment agent according to claim 7, wherein the aqueous polyurethane resin is an aqueous polyurethane resin that is a chain-extended product of a neutralized product of an isocyanate group-terminated prepolymer which is a reaction product of (a) an organic polyisocyanate, (b) a polyol, (c) a compound having an anionic hydrophilic group and at least two active hydrogens, and (d) a polyhydric alcohol, the chain-extended product being obtained by chain-extending the neutralized product with (e) a polyamine having two or more amino groups and/or imino groups, wherein
the (b) polyol contains at least one selected from the group consisting of (b1) polycarbonate diols each having a structural unit derived from a diol having a branched structure with an integer of 3 to 10 carbon atoms and (b2) polycarbonate diols each having a structural unit derived from a diol having a linear structure with an odd number of 3 to 9 carbon atoms, and
the (d) polyhydric alcohol contains a polyhydric alcohol having at least three or more active hydrogens.

9. Leather comprising a leather base material and a surface treatment layer formed on a surface of the base material with the surface treatment agent according to claim 7.

10. The aqueous polyurethane resin according to claim 2, wherein
a ratio of a total amount of the polycarbonate diols (b1) and (b2) in the (b) polyol is 40% by mass or more.

11. The aqueous polyurethane resin according to claim 2, wherein
a ratio of the (d) polyhydric alcohol to a total amount of the (b) polyol, the (c) compound having an anionic hydrophilic group and at least two active hydrogens, and the (d) polyhydric alcohol is 0.1 to 1.5% by mass.

12. The aqueous polyurethane resin according to claim 2, wherein
a content of free isocyanate groups in the isocyanate group-terminated prepolymer is 0.2 to 4.0% by mass.

13. The aqueous polyurethane resin according to claim 2, wherein
the (a) organic polyisocyanate is at least one selected from the group consisting of aliphatic polyisocyanates and alicyclic polyisocyanates.

14. The surface treatment agent according to claim 8, wherein
the (b1) polycarbonate diol is a polycarbonate diol having the structural unit derived from the diol having the branched structure with an integer of 3 to 10 carbon atoms and a structural unit derived from a diol having a linear structure with an integer of 3 to 10 carbon atoms, and
the (b2) polycarbonate diol is at least one selected from the group consisting of a polycarbonate diol having the structural unit derived from the diol having the linear structure with an odd number of 3 to 9 carbon atoms and a structural unit derived from a diol having a linear structure with an even number of 4 to 10 carbon atoms and a polycarbonate diol having a structural unit derived from only the diol having the linear structure with an odd number of 3 to 9 carbon atoms.

15. Leather comprising a leather base material and a surface treatment layer formed on a surface of the base material with the surface treatment agent according to claim 8.

16. Leather comprising a leather base material and a surface treatment layer formed on a surface of the base material with the surface treatment agent according to claim 14.
